(19) United States
(12) Patent Application Publication
(10) Pub. No.: US 2026/0183736 A1
(43) Pub. Date: Jul. 2, 2026

(54) FLUID CHANNEL SEGMENT WITH STUD ARRANGEMENT AND FLUID PATH HAVING SAID FLUID CHANNEL SEGMENT

(71) Applicant: CORNING INCORPORATED, CORNING, NY (US)

(72) Inventors: Ivan Nikolaevich Ivukin, Avon (FR); Elias Merhy, Saulx-Les-Chartreux (FR); Quentin Jean André Pierron, Nancy (FR)

(21) Appl. No.: 18/869,059

(22) PCT Filed: May 31, 2023
(86) PCT No.: PCT/US2023/023958

§ 371 Date: Nov. 25, 2024

Related U.S. Application Data
(60) Provisional application No. 63/348,725, filed on Jun. 3, 2022.

(51) Int. Cl. B01J 19/00

(52) U.S. Cl. CPC B01J 19/0053; B01J 2219/00761; B01J 2219/2474

(57) ABSTRACT

A fluid channel segment includes a fluid passage segment that extends through a portion of a body. The fluid passage segment has a longitudinal axis in an axis plane, a passage height, a passage width, and a flow direction. The fluid channel segment also includes studs arranged in a sequence. The studs extend across the fluid passage segment with the passage height. No more than two studs are positioned across the passage width. Each stud has a continuous peripheral surface. The surface has a common elongate shape that is symmetrical about a stud axis passing through a common reference point on each stud. The studs are spaced axially from each with a nonzero axial offset. The stud axis of each stud forms a nonzero angle with a tangent to the longitudinal axis. The nonzero angle of the first 2 studs in the sequence has the same direction from the tangent.

### CROSS-REFERENCE TO RELATED APPLICATIONS

This application claims the benefit of priority under 35 U.S.C. § 119 of U.S. Provisional Application No. 63/348,725 filed Jun. 3, 2022, the content of which is incorporated herein by reference in its entirety.

### FIELD

The present disclosure relates to fluid paths with microchannels and, more particularly, microchannels with stud arrangements configured to enable high-volume fluid throughput while maintaining mixing quality and reliability.

### BACKGROUND

Flow reactors are used in the chemical industry for continuous flow reactions. The reactor can include different components such as fluid modules, piping, connectors, frames, O-rings, etc. Some fluid modules are configured as an assembly of two inner reactive layers with reactive channels in which chemical reactions take place and two outer heat exchange layers which role is to maintain the reactive channels temperature at an optimal value. Existing fluid modules are compact and easily scalable reactor plates formed of glass or ceramic, such as silicon carbide. Applicant has developed several generations of fluid modules, which correspond largely to different sizes or internal volumes. Applicant has more recently developed a larger fluid module configured to enable a flow rate up to 20 L/min under a reaction pressure of up to 18 bar. Such modules are typically proof tested at 50 bar.

It would be advantageous to provide higher-throughput fluid modules configured to enable a flow rate up to 40 L/min without compromising the mixing quality, pressure drop, and reliability/safety.

### SUMMARY

A first aspect of the present disclosure includes a fluid channel segment comprising a fluid passage segment extending through a portion of a body, the fluid passage segment having a longitudinal axis that lies substantially in an axis plane, a passage height normal to the axis plane, a passage width normal to the passage height and the longitudinal axis, and a flow direction through the fluid passage segment, and a plurality of studs arranged in a sequence along the fluid passage segment, wherein each stud extends across the fluid passage segment with a stud height corresponding to the passage height of the fluid passage segment, wherein no more than two studs are positioned across the passage width of the fluid passage segment, wherein each stud has a continuous surface that defines a periphery of the stud, the continuous surface having a common elongate shape that is symmetrical about a symmetry plane oriented parallel to the stud height and, when viewed in the axis plane, the symmetry plane corresponds to a stud axis of each stud that passes through a common reference point on each stud, the studs are spaced from each other in the flow direction with a nonzero axial offset relative to the longitudinal axis, and wherein the stud axis of each stud has a nonzero angle α with a tangent to the longitudinal axis at an intersection of the longitudinal axis with a line that is normal thereto and passes through the common reference point, the nonzero angle of the first 2 studs in the sequence having the same direction relative to the tangent.

A second aspect of the present disclosure includes a fluid channel segment comprising a fluid passage segment extending through a portion of a body, the fluid passage segment having a longitudinal axis that lies substantially in an axis plane, a passage height normal to the axis plane, a passage width normal to the passage height and the longitudinal axis, and a flow direction through the fluid passage segment, and a plurality of studs arranged in a sequence along the fluid passage segment, wherein each stud extends across the fluid passage segment with a stud height corresponding to the passage height of the fluid passage segment, wherein no more than two studs are positioned across the passage width of the fluid passage segment, wherein each stud has a continuous surface that defines a periphery of the stud, the continuous surface having a common elongate shape that is symmetrical about a symmetry plane oriented parallel to the stud height and, when viewed in the axis plane, the symmetry plane corresponds to a stud axis of each stud that passes through a common reference point on each stud, wherein the studs are spaced from each other in the flow direction with a nonzero axial offset relative to the longitudinal axis, wherein the stud axis of each stud has a nonzero angle α with a tangent to the longitudinal axis at an intersection of the longitudinal axis with a line that is normal thereto and passes through the common reference point, and wherein the continuous surface of each stud comprises two convex faces spaced apart at opposing ends of the stud and two planar faces connecting the two convex faces at respective tangents thereof, the two convex faces comprising an upstream face and a downstream face positioned upstream and downstream, respectively, along the fluid passage segment relative to the flow direction, the upstream face having a first radius and the downstream face having a second radius that is larger than the first radius.

A third aspect of the present disclosure includes a fluid path, comprising: the fluid channel segment according to the first aspect, the fluid passage segment of the fluid channel segment defining a portion of a fluid passage extending through the body, an inlet disposed at a first end of the fluid passage, the inlet configured to separate at least two fluids introduced concurrently to the fluid passage via the inlet, an outlet disposed at a second end of the fluid passage spaced from the first end, the flow direction configured to convey the at least two fluids from the inlet, through the fluid channel segment, and to the outlet, and a mixer unit disposed upstream from the fluid channel segment along the fluid passage relative to the flow direction, the mixer unit configured to mix the at least two fluids.

### BRIEF DESCRIPTION OF THE DRAWINGS

FIG. 1 is a top perspective view of a fluid device comprising a fluid path for continuous flow reactions;

FIG. 2 is a block diagram of an embodiment of the fluid path of FIG. 1:

FIG. 3 is a top view of the fluid device of FIG. 1 with a top surface portion cut away to expose an embodiment of a fluid channel segment of the fluid path;

FIG. 4 is a top view of the fluid device of FIG. 1 with atop surface portion cut away to expose an embodiment of a fluid channel segment of the fluid path;

FIG. 5 is a sectional view of the fluid channel segment of FIG. 3 along line A-A.

FIG. 6 is a top perspective view of the fluid device of FIG. 1 with a top portion removed to show the fluid channel segment of FIG. 3 with a plurality of studs;

FIG. 7 is a sectional view depicting attributes of studs in embodiments;

FIG. 8 is a top schematic view of a coordinate system for indicating positions of studs relative to a longitudinal axis of a fluid channel segment in embodiments;

FIGS. 9 and 10 are top schematic views of a scheme for indicating angular orientations of studs relative to a longitudinal axis of a fluid channel segment in embodiments;

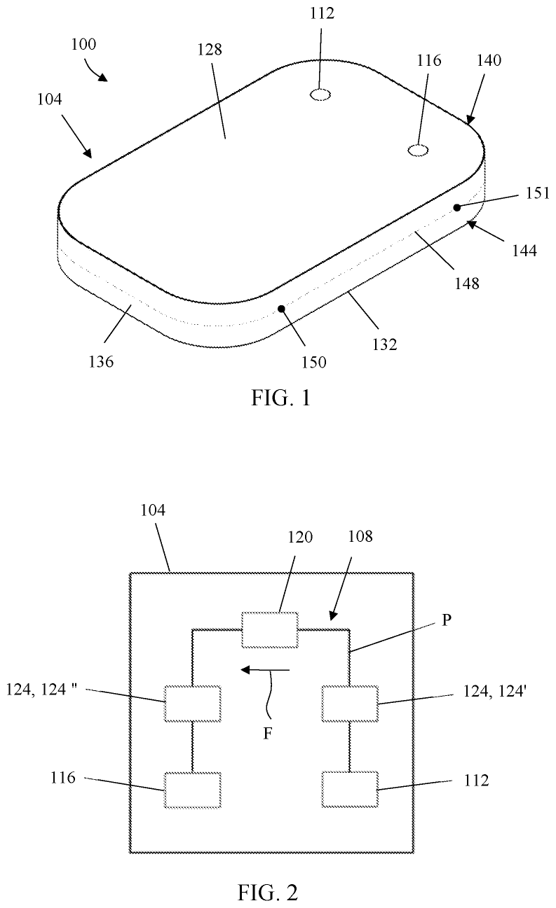

FIG. 1 is a top schematic view of an embodiment of an inlet structure for the fluid path of FIG. 1;

FIG. 12 is a top schematic view of an embodiment of a mixer structure for the fluid path of FIG. 1;

FIG. 13 is a bar chart comparing the maximum computed stresses at different positions along fluid paths according to Examples 1-4 and Comparative Example 1; and

FIG. 14 is a bar chart illustrating total pressure drop along the fluid paths of Examples 1-4 and Comparative Example 1.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial.” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In embodiments, “substantially” may denote values within about 10% of each other, such as within about 5% of each other, or within about 2% of each other, or within about 1% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “tortuous” when used in connection with the terms passage, channel, or the like refers to a passage having no line of sight directly through the passage and with a path of the passage having at least two differing radii of curvature, the path of the passage being defined mathematically and geometrically as a curve formed by successive geometric centers, along the passage, of successive minimum-area planar cross sections of the passage (that is, the angle of a given planar cross section is the angle which produces a minimum area of the planar cross section at the particular location along the passage) taken at arbitrarily closely spaced successive positions along the passage. Typical machining-based forming techniques are generally inadequate to form such a tortuous passage. Such passages may include a division or divisions of a passage into subpassages (with corresponding subpaths) and a recombination or recombinations of subpassages (and corresponding subpaths).

As used herein, the term “monolithic” when used in connection with the terms structure, body, or the like does not imply zero inhomogeneities in the structure or body at all scales. Instead, “monolithic” refers to a body, such as a ceramic body, with one or more tortuous passages extending therethrough, in which (other than the passage(s)) no inhomogeneities, openings, and/or interconnected porosities are present in the body having a length greater than the average perpendicular depth of the one or more passages P from the external surface of the body. For bodies with other geometries, such as non-planar or circular geometries, the term “monolithic” refers to a body with one or more tortuous passages extending therethrough, in which (other than the passage(s)) no inhomogeneities, openings, and/or interconnected porosities are present in the body having a length greater than (i) the minimum depth of the one or more passages P from the external surface of the body and (ii) the minimum spacing between separate, spaced-apart portions of the one or more passages P from one another. Fluidic ports that are machined and/or molded in the body so as to purposely enable fluid communication from the outside of the body to the passages and/or between separate, spaced-apart portions of the passages, such as inlet ports and/or outlet ports, are excluded from the determination of the average perpendicular depth, the minimum depth, and/or the minimum spacing. Providing such a monolithic structure or monolithic body helps ensure fluid tightness and good pressure resistance of a fluid device or similar product.

As used herein, the term “monolithic” may additionally or alternatively refer to a body of sintered polycrystalline ceramic material with a chain of grains having a continuous and uniform distribution through an entirety of the body in any direction, such as when grain growth occurs concurrently during a single sintering cycle, yet where the body may include internal passages, as disclosed herein, and interstitial pores between grains, and optionally where most interstitial pores have a maximum crosswise dimension of less than 5 μm, such as in the range of from 2 to 3 μm, and/or where the body is free of separate components (e.g. halves of the body) bonded to one another at a joint (observable and/or detectible), such as at a joining plane. A joint may be observable and/or detectible, for example, by the naked eye, microscopic analysis of cross sections, scanning electron microscopy (SEM), far-infrared reflectivity spectroscopy, electron backscatter diffraction (EBSD), surface profilometer measurement after etching, compositional variations through Auger electron spectroscopy (AES), X-ray photoelectron spectroscopy (XPS), and/or x-ray CT scanning. A joint may be indicated by a sharp change in porosity, composition, and/or density of the material in any direction through the body. A joint may also be indicated by a disruption or an incongruity in the distribution of grains through the material.

Referring now to FIGS. 1-6, a fluid device 100 for continuous flow reactions is disclosed. The fluid device 100 comprises a body 104 and a fluid path 108 arranged in the body 104. The fluid path 108 comprises a fluid passage P that extends through the body 104 and a plurality of fluid structures disposed along the fluid passage P in fluid communication with one another. The fluid structures include an inlet 112 disposed at a first end of the fluid passage P and an outlet 116 disposed at a second end of the fluid passage P spaced from the first end. In embodiments, the inlet 112 is configured to separately convey at least two fluids introduced concurrently to the fluid passage P via the inlet 112. The fluid path 108 is configured to mix and convey the at least two fluids along the fluid passage P in a flow direction from the inlet 112 to the outlet 116 as indicated by arrow F. The fluid structures further include a fluid channel segment 120 and at least one mixer unit 124 each of which is disposed intermediate the inlet 112 and the outlet 116 along the fluid passage P. The fluid path 108 in embodiments can include further fluid structures, such as residence time channels, separation units, and/or interfaces for in-line analysis. The fluid structures can be disposed adjacent to one another along the fluid path 108 or spaced from one another along the fluid path 108 while fluidically connected via one or more segments of the fluid passage P.

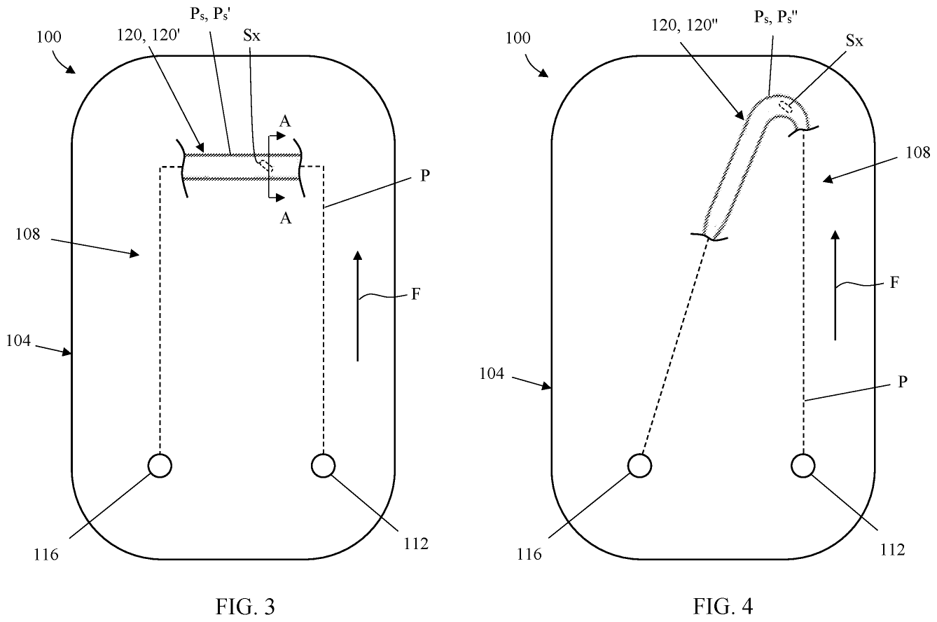

In embodiments, the at least one mixer unit 124 includes a plurality of mixer units 124 in various configurations and/or multiple positions along the fluid passage P. The mixer units 124 in embodiments can include a first group of mixer units 124′ arranged in parallel and/or serially with respect to each other and positioned between the inlet 112 and the fluid channel segment 120. The mixer units 124 in embodiments can additionally or alternatively include a second group of mixer units 124″ arranged in parallel and/or serially with respect to each other and positioned between the outlet 116 and the fluid channel segment 120. The block diagram of FIG. 2 depicts an exemplary embodiment of the flow path 108 with the inlet 112, the first group of mixer units 124′, the fluid channel segment 120, the second group of mixer units 124″, and the outlet 116 positioned relative to one another along the flow path 108. The inlet 112 and the mixer units 124, 124′, 124″ are described in more detail later in this disclosure with reference to FIGS. 11 and 12.

The body 104 of the fluid device 100 can have various shapes. In embodiments, the body 104 has a plate-like shape with a top surface 128, a bottom surface 132 opposed to the top surface 128, and an edge 136 connecting the top surface 128 and the bottom surface 132 at respective peripheries thereof. The top surface 128 and the bottom surface 132 in embodiments are substantially planar. The body 104 in embodiments can be a unified body that comprises separate components bonded to one another at a joint, such as at a joining plane. For example, as shown in FIG. 1, the body 104 can include a first or top body portion 140 and a second or bottom body portion 144 bonded to the top body portion 140 at a joining plane 148. The body 104 in embodiments can be a monolithic body such that the body is free of separate components (e.g., halves of the body) bonded to one another at a joint (observable and/or detectible), such as at a joining plane. In embodiments, the fluid passage P can be a tortuous fluid passage that extends through the unified body or the monolithic body.

The body 104 of the fluid device 100 can be formed from a material that comprises one or more of ceramic, metal, glass, and glass ceramic. In embodiments in which the material of the body 104 is metal, the metal material can include stainless steels, such as 316L stainless steel and Hastelloy@, and other metals. In embodiments in which the material of the body 104 is ceramic, the ceramic material can include oxide ceramics, non-oxide ceramics, glass-ceramics, and other ceramics that enable high density, closed-porosity structures or bodies. Oxide ceramics are inorganic compounds of metallic (e.g., Al, Zr, Ti, Mg) or metalloid (Si) elements with oxygen. Oxides can be combined with nitrogen or carbon to form more complex oxynitride or oxycarbide ceramics. Non-oxide ceramics are inorganic, non-metallic materials and include carbides, nitrides, borides, silicides, and others. Some examples of non-oxide ceramics that can be used for the body 104 include boron carbide (B4C), boron nitride (BN), tungsten carbide (WC), titanium diboride (TiB2), zirconium diboride (ZrB2), molybdenum disilicide (MoSi2), silicon carbide (SiC), and silicon nitride (Si3N4). As used herein, a “closed-porosity” ceramic body is a ceramic body in which the ceramic material of the ceramic body exhibits a pore topology that is closed such that the pores or cells in the material are isolated or connected only with adjacent pores or cells and have no permeability to fluid.

In embodiments in which the material of the body 104 is ceramic, the ceramic material can include any pressable powder that is held together by a binder and thermally processed to fuse the powder particles together into the body. The body 104 in an exemplary embodiment is formed from SiC. In such an embodiment, the pressable powder can comprise a ready-to-press (RTP) SiC powder that includes binder(s) and/or other additives mixed with or coated thereon to facilitate pressing. Examples of such RTP SiC powder include SICS-18 from GNPGraystar of Buffalo, NY, United States; IKH 601 and 604 from Industriekeramik Hochrhein (IKH) GmbH of Wutoschingen, Germany; and StarCeram S alpha-SiC types SQ and RQ from KYOCERA Fineceramics Precision GmbH of Selb, Germany.

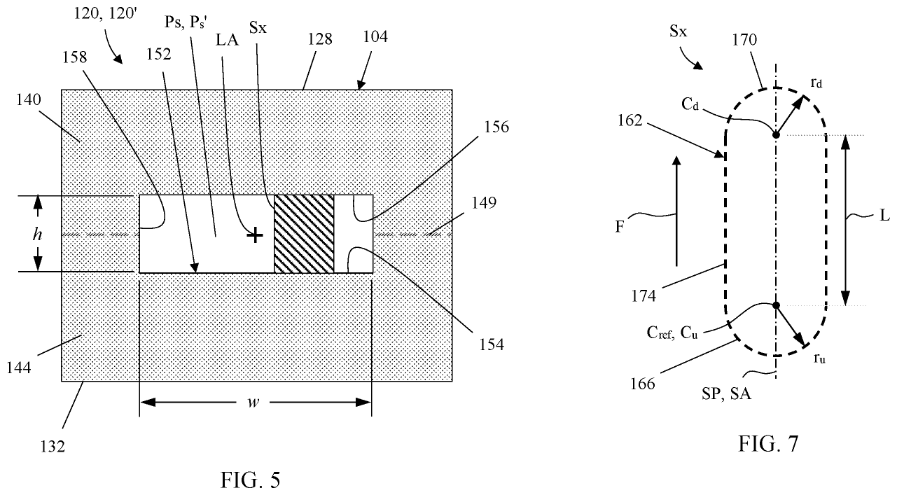

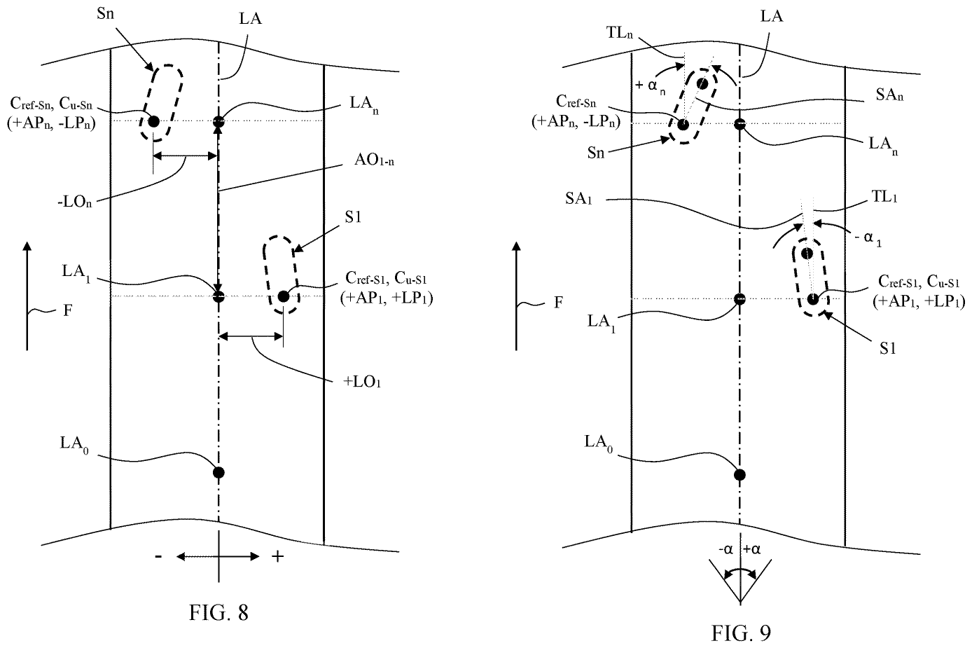

Referring now to FIGS. 3-10, aspects of the fluid channel segment 120 are disclosed. The fluid channel segment 120 comprises a fluid passage segment Pₛ that extends through a portion of the body 104. The fluid passage segment Pₛ is coextensive with the fluid passage P within the fluid channel segment 120 such that the fluid passage segment Pₛ defines a portion of the fluid passage P. As shown in FIGS. 5 and 8-10, the fluid passage segment Pₛ has a longitudinal axis LA that corresponds to a theoretical line passing through the centroid of sequential cross sections of the fluid passage segment Pₛ along the long axis of the fluid channel segment 120.

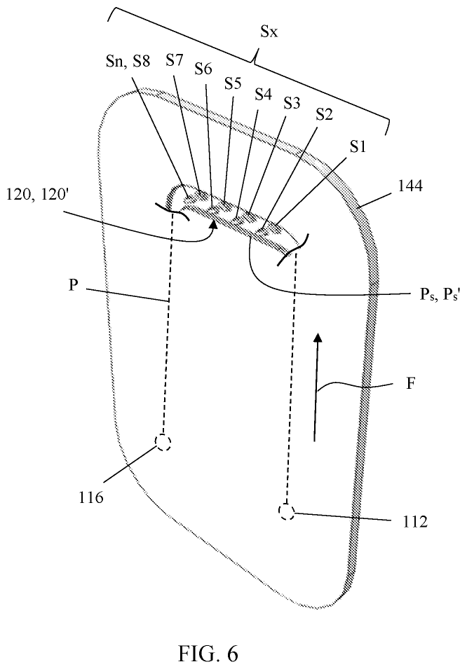

FIG. 3 depicts the fluid channel segment 120 as a straight fluid channel segment 120′. The straight fluid channel segment 120′ has a straight fluid passage segment Pₛ′ with a longitudinal axis LA that extends only in a linear direction along an entire length of the straight fluid channel segment 120′. FIG. 4 depicts the fluid channel segment 120 as a curved fluid channel segment 120″. The curved fluid channel segment 120″ has a curved fluid passage segment Pₛ″ with a longitudinal axis LA that has one or more curved portions along an entire length of the curved fluid channel segment 120″. In embodiments, the one or more curved portions of the longitudinal axis LA is disposed at an upstream end of the curved fluid passage segment Pₛ″, a downstream end of the curved fluid passage segment Pₛ″, or both the upstream end and the downstream end of the curved fluid passage segment Pₛ″.

In exemplary embodiments, the longitudinal axis LA of the straight fluid channel segment Pₛ′ (FIG. 3) and the longitudinal axis LA of the curved fluid channel segment Pₛ″ (FIG. 4) each lie substantially in a single plane interchangeably referred to as an axis plane 149 (FIG. 5). The axis plane 149 in embodiments is substantially parallel to the top surface 128 and the bottom surface 132 of the body 104. The axis plane 149 in embodiments corresponds to a midplane of the body 104 positioned at approximately one-half the orthogonal distance between the top surface 128 and the bottom surface 132. In other embodiments, the longitudinal axis LA of the curved fluid passage segment Pₛ″ does not lie in a single plane such that longitudinal axis LA is a space curve.

FIG. 5 depicts a cross section through the straight fluid channel segment 120′ of FIG. 3 along line A-A. This cross section is oriented normal to the longitudinal axis LA. As shown in FIG. 5, the straight fluid passage segment Pₛ′ comprises an interior surface 152 that encircles the longitudinal axis LA. The interior surface 152 can have any cross-sectional shape suitable for conveying fluids through the straight fluid passage segment Pₛ′. For example, the interior surface 152 can have a quadrilateral cross-sectional shape, such as a square or rectangular shape, as shown in the exemplary embodiment of FIG. 5. The interior surface 152 in embodiments can have a circular cross-sectional shape. The interior surface 152 in embodiments can have a cross-sectional shape that is neither circular nor polygonal, for example, an oval cross-sectional shape. For such geometries, the hydraulic diameter of the cross section can provide a parameter for describing the geometry and the flow characteristics of the straight fluid passage segment Pₛ′.

In embodiments in which the interior surface 152 has a quadrilateral (rectangular) cross-sectional shape, as shown in FIG. 5, the straight fluid passage segment Pₛ′ comprises a floor 154 and a ceiling 156 separated by a passage height h and two opposing sidewalls 158 joining the floor 154 and the ceiling 156. The sidewalls 158 are separated by a passage width w. The passage height h is normal to the longitudinal axis LA, and the passage width K is normal to the passage height h and the longitudinal axis LA. In embodiments in which the longitudinal axis LA lies substantially in the axis plane 149, the passage height h is normal to the axis plane 149. In embodiments in which the interior surface 152 comprises walls and/or wall portions that intersect, such as the embodiment depicted in FIG. 5, the walls and/or wall portions can include a fillet at the intersection(s) thereof. For example, the interior surface 152 can include a fillet (not shown) at the intersection of the floor 154 and the sidewalls 158 and/or at the the intersection of the ceiling 156 and the sidewalls 158.

The passage height h in embodiments is in a range from 0.1 mm to 20 mm, or from 2 mm to 14 mm, or from 4 mm to 12 mm, or from 3 mm to 12 mm, or from 2 mm to 12 mm, or from 4 mm to 13 mm, or from 4 mm to 14 mm, or from 6 mm to 10 mm, or from 5 mm to 10 mm, or from 4 mm to 10 mm, or from 6 mm to 11 mm, or from 6 mm to 12 mm. The passage width w in embodiments is in a range from 15 mm to 40 mm, or from 20 mm to 35 mm, or from 18 mm to 35 mm, or from 16 mm to 35 mm, or from 20 mm to 37 mm, or from 20 mm to 39 mm, or from 25 mm to 30 mm, or from 20 mm to 30 mm, or from 15 mm to 30 mm, or from 25 mm to 35 mm, or from 25 mm to 40 mm. In embodiments, the passage width w is measured at a position corresponding to one-half of the passage height h. Unless indicated otherwise in this disclosure, the curved fluid channel segment 120″ includes the same features described with reference to FIG. 5 in connection with the straight fluid channel segment 120′ (e.g., the interior surface 152, the floor 154, the ceiling 156, the two opposing sidewalls 158, the passage height h, the passage width w, and other features).

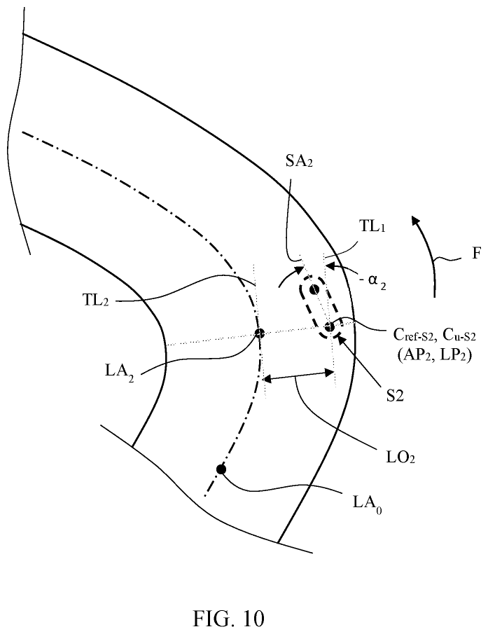

As best shown in FIG. 6, the fluid channel segment 120 includes a plurality of studs Sx arranged in a sequence along the fluid passage segment Pₛ. As used herein, the modifier “x” used with reference character “S” refers generally to any or all studs in the sequence. The modifiers “1,” “2,” “3,” and so on used with reference character “S” refers to the serial position of the stud in the sequence. For example, S1 refers to the first stud in the sequence, S2 refers to the second stud in the sequence, and so on. The modifier “n” used with reference character “S” refers to the last stud in the sequence without regard to a total number of studs in the sequence. For example, no matter if the fluid channel segment 120 comprises 8 studs (as shown in FIG. 6), 11 studs, or 16 studs, Sn refers to the last stud in the sequence. The shape, size, position, and/or orientation of the studs as well as the geometry and/or size of the fluid passage segment are configured to enable high throughput fluid devices (i.e., devices having a flow rate of at least 40 L/min) without comprising mixing quality, pressure drop, or reliability/safety.

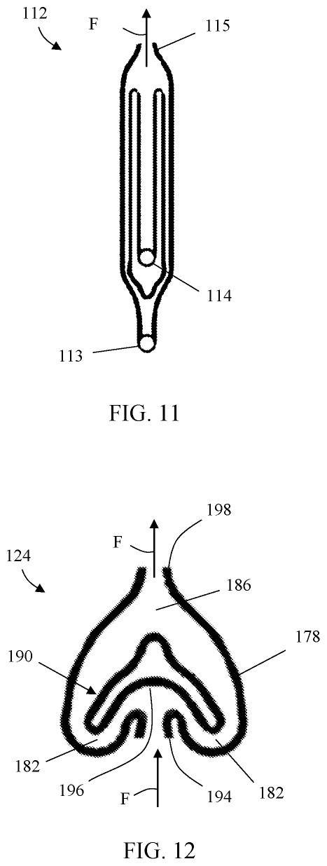

As best shown in FIG. 5, each stud Sx extends across the fluid passage segment Pₛ with a stud height that corresponds to the passage height h such that the studs Sx extend entirely across the fluid passage segment Pₛ. In embodiments in which the interior surface 152 of the fluid passage segment Pₛ has the quadrilateral-cross sectional shape, the studs Sx extend from the floor 154 to the ceiling 156 of the fluid passage segment Pₛ. FIG. 7 is a sectional view that depicts a cross section through the stud Sx of FIG. 5 along the axis plane 149 to illustrate attributes of the studs Sx. In embodiments, the axis plane 149 coincides with the midplane of the body 104. In embodiments, the axis plane 149, the midplane, and the joining plane 148 (FIG. 1) are the same plane. In embodiments, the studs Sx extend from the axis plane 149, the midplane, and/or the joining plane.

With continued reference to FIG. 7, each stud Sx has a continuous surface 162 that defines a periphery of the stud Sx. The studs Sx preferably include a fillet (not shown) at the intersection of the continuous surface 162 and the interior surface 152 of the fluid passage segment Pₛ, for example, at the floor 154 and the ceiling 156 of the interior surface 152. The continuous surface 162 has a common elongate shape that is symmetrical about a symmetry plane SP oriented parallel to the stud height and, when viewed in the axis plane 149, the symmetry plane SP corresponds to a stud axis SA of each stud Sx that passes through at least one common reference point C_{ref}. The continuous surface 162 is depicted in dashed line type to indicate the common elongate shape can have a different shape and/or dimensions than shown in FIG. 7 as long as all studs Sx in the sequence have the same common elongate shape. In alternative embodiments, one or more of the studs Sx in the sequence can have an elongate shape that is different than the common elongate shape. In embodiments, the continuous surface 162 comprises two convex faces 166, 170 spaced apart at opposing ends of the stud Sx and two planar faces 174 connecting the two convex faces 166, 170 at respective tangents thereof. In embodiments, such as shown in FIG. 7, the continuous surface 162 comprises exactly two convex faces 166, 170 spaced apart at opposing ends of the stud Sx and exactly two planar faces 174 connecting the two convex faces 166, 170 at respective tangents thereof. The two convex faces 166, 170 and the two planar faces 174 are substantially convex and substantially planar, respectively, in embodiments.

The two convex faces 166, 170 comprise an upstream face 166 positioned upstream along the fluid passage segment Pₛ relative to the flow direction F and a downstream face 170 positioned downstream along the fluid passage segment Pₛ relative to the flow direction F. Due to the positioning and orientation of the studs Sx in the fluid passage segment Ps, as described in more detail later in this disclosure, fluid flowing through the fluid passage segment Pₛ will pass and/or interact with the upstream face 166 of the stud Sx before the same fluid passes and/or interacts with the downstream face 170. The upstream face 166 and the downstream face 170 each have a radius, which is indicated by rᵤ (e.g., upstream radius) and r_{d} (e.g., downstream radius), respectively, in FIG. 7.

The radius of each of the upstream face 166 and the downstream face 170 in embodiments is in a range of from 1.850 mm to 2.800 mm, or from 1.925 mm to 2.725 mm, or from 2.075 mm to 2.775 mm, or from 1.875 mm to 2.575 mm, or from 2.000 mm to 2.650 mm, or from 2.075 mm to 2.675 mm, or from 1.975 mm to 2.575 mm, or from 2.075 mm to 2.575 mm, or from 2.075 mm to 2.475 mm, or from 2.175 mm to 2.575 mm, or from 2.150 mm to 2.500 mm, or from 2.075 mm to 2.375 mm, or from 2.275 mm to 2.575 mm, or from 2.225 mm to 2.425 mm, or from 2.300 mm to 2.350 mm, and also comprising all sub-ranges and sub-values between and comprising 1.5 mm and 3 mm.

In embodiments, the upstream radius rᵤ of the upstream face 166 and the downstream radius r_{d} of the downstream face 170 are identical for all the studs Sx of the fluid channel segment 120. In embodiments, the upstream radius rᵤ of the upstream face 166 and the downstream radius r_{d} of the downstream face 170 are different for all the studs Sx of the fluid channel segment 120 such that one of the upstream radius rᵤ and the downstream radius r_{d} of each stud Sx is larger than the other. In an exemplary embodiment, the downstream radius r_{d} is larger than the upstream radius rᵤ for all the studs Sx of the fluid channel segment 120. In another embodiment, the upstream radius rᵤ is larger than the downstream radius r_{d} for all the studs Sx of the fluid channel segment 120. In further embodiments, the downstream radius r_{d} is larger than the upstream radius rᵤ for some studs Sx of the fluid channel segment 120 while the upstream radius rᵤ is larger than the downstream radius r_{d} for other studs Sx of the fluid channel segment 120.

In embodiments, each stud Sx has an upstream center Cu at the center of curvature of the upstream face 166 when viewed in the axis plane 149. Similarly, each stud Sx has downstream center Ca at the center of curvature of the downstream face 170 when viewed in the axis plane 149. In such embodiments, the radii of the two convex faces 166, 170 are constant along an entirety of the two convex faces 166, 170 such that the respective centers of curvature of the two convex faces 166, 170 are fixed in position. The upstream center Cᵤ or the downstream center C_{d} corresponds to the at least one common reference point C_{ref} in embodiments. As shown in FIG. 7, the stud axis SA of each stud Sx passes through the upstream center Cᵤ and the downstream center C_{d} when viewed in the axis plane 149. In embodiments, the radius of one or both of the two convex faces 166, 170 can vary along the entirety or portions of the two convex faces 166, 170 such that the upstream face 166 and/or the downstream face 170 has a center of curvature that varies in position along that convex face.

The studs Sx each have a stud length L measured between the upstream center Cᵤ and the downstream center C_{d}. In embodiments, the stud length L is in a range of from 6.185 mm to 7.135 mm, or from 6.260 mm to 7.060 mm, or from 6.410 mm to 7.110 mm, or from 6.210 mm to 6.910 mm, or from 6.335 mm to 6.985 mm, or from 6.410 mm to 7.010 mm, or from 6.310 mm to 6.910 mm, or from 6.410 mm to 6.910 mm, or from 6.410 mm to 6.810 mm, or from 6.510 mm to 6.910 mm, or from 6.485 mm to 6.835 mm, or from 6.410 mm to 6.710 mm, or from 6.610 mm to 6.910 mm, or from 6.560 mm to 6.760 mm, or from 6.635 mm to 6.685 mm, and also comprising all sub-ranges and sub-values between and comprising 5.750 mm and 7.250 mm. An overall length of each stud Sx is determined by adding together the stud length L, the upstream radius rᵤ, and the downstream radius r_{d}.

Referring to FIG. 6, the fluid channel segment 120 in embodiments has no more than two studs Sx positioned across the passage width w of the fluid passage segment Pₛ, for example, when viewed in any cross section oriented normal to the longitudinal axis LA along the entire length of the fluid channel segment 120. In embodiments, the fluid channel segment 120 has one or more first portions in which there are no more than two studs Sx positioned across the passage width w and one or more second portions in which there are more than two studs Sx positioned across the passage width w.

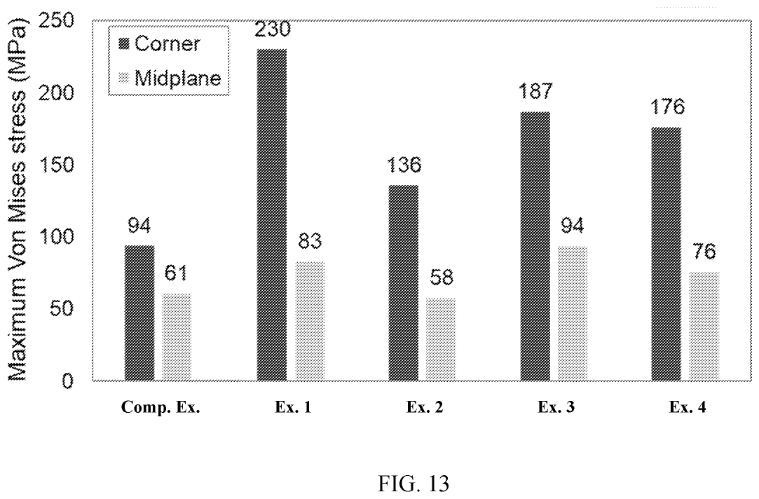

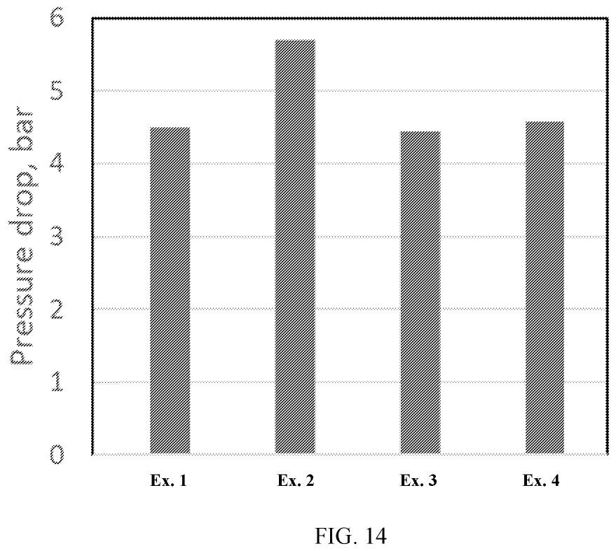

FIGS. 8-10 are a schematic cross sectional views through the fluid channel segment 120 along the axis plane 149, as viewed if facing in the direction of the top surface 128 of the body 104 from outside the fluid device 100, so as to illustrate a coordinate system for indicating positions (FIG. 8) and/or orientations (FIGS. 9 and 10) of the studs Sx relative to the longitudinal axis LA of the fluid passage segment Pₛ. The positions and/or orientations of the studs Sx are indicated with respect to the common reference point C_{ref} of each stud Sx (i.e., the upstream center Cᵤ in the exemplary embodiment of FIG. 7). The position of each stud Sx can be defined in the coordinate system by (1) an axial component along the longitudinal axis LA and corresponding to an axial position AP of the common reference point C_{ref} of each stud Sx and (2) a lateral component orthogonal to the longitudinal axis LA and corresponding to a lateral position LP of the common reference point C_{ref} of each stud Sx.

As used herein, the subscripts “1,” “2,” “3,” and so on used with reference character “AP” refers to the axial positions of the first stud S1, the second stud S2, the third stud S3, and so on, respectively, in the sequence. The subscript “n” used with reference character “AP” refers to the axial position of the last stud Sn in the sequence. Similarly, the subscripts “1,” “2,” “3,” and so on used with reference character “LP” refers to the lateral positions of the first stud S1, the second stud S2, the third stud S3, and so on, respectively, in the sequence. The subscript “n” used with reference character “LP” refers to the lateral position of the last stud Sn in the sequence. For example, as shown in FIG. 8, the position of first stud S1 at the common reference point C_{ref-S1} comprises an axial position AP₁ and a lateral position LP₁. The position of the last stud Sn at the common reference point C_{ref-Sn} comprises an axial position APN and a lateral position LPₙ.

The axial position AP of a given stud Sx corresponds to a distance along the longitudinal axis LA between an axial position reference point on the longitudinal axis LA and a stud reference point of the given stud Sx on the longitudinal axis LA. The stud reference point is indicated on the longitudinal axis LA at the intersection of a stud position line (an imaginary line) that is normal or substantially normal to the longitudinal axis LA and passes through the common reference point C_{ref} of the given stud Sx. For example, as shown in FIG. 8, the stud reference point of the first stud S1 in the sequence is indicated at LA₁ on the longitudinal axis LA and the stud reference point of the last stud Sn in the sequence is indicated at LAₙ on the longitudinal axis LA. The stud position line is shown in FIGS. 8-10 as a dashed line that extends across the passage width w and orthogonally relative to the longitudinal axis LA.

The axial position reference point can be any fixed point on the longitudinal axis LA. In embodiments, as shown in FIG. 8, the axial position reference point is upstream relative to the flow direction F from the first stud S1 as indicated by LA₀. Alternatively, the axial position reference point can be the stud reference point of any stud Sx in the sequence, for example, the stud reference point LA₁ of the first stud S1 in the sequence. In embodiments, the axial position AP of a given stud Sx upstream or downstream of the axial position reference point can be indicated by using a negative sign (−) or a positive sign (+) before the value of the axial position. In a first sign convention, a negative axial position (−AP) can indicate a stud reference point of a given stud Sx positioned upstream from the axial position reference point and a positive axial position (+AP) can indicate a stud reference point positioned downstream from the axial position reference point. In a second sign convention, a positive axial position (+AP) can indicate a stud reference point of a given stud Sx positioned upstream from the axial position reference point and a negative axial position (−AP) can indicate a stud reference point positioned downstream from the axial position reference point. The first sign convention is followed in the exemplary embodiment depicted in FIG. 8.

The distance along the longitudinal axis LA between the stud reference points of any two studs in the sequence defines an axial offset AO between those studs. In embodiments, the studs are spaced from each other in the flow direction with a nonzero axial offset relative to the longitudinal axis LA such that no studs share the same stud reference point. FIG. 8 illustrates the nonzero axial offset between the first stud S1 and a next stud Sn. Though “Sn” has been previously described as referring to the last stud in the sequence, for purposes of illustrating the axial offset, Sn refers to the immediately next stud in the sequence in the flow direction F. The nonzero axial offset between S1 and Sn is the distance along the longitudinal axis LA between LA₁ and LAₙ as indicated by the arrow AO₁₋ₙ in FIG. 8. The sign convention (− or +) discussed with respect to the axial position AP can be used in the same manner to denote the direction of the axial offset AO upstream or downstream between studs.

The lateral position LP of a given stud Sx corresponds to a distance along the corresponding stud position line between the stud reference point of the given stud Sx on the longitudinal axis LA and the common reference point C_{ref} of the given stud. In embodiments, the lateral position LP of a given stud Sx to the left or right of the longitudinal axis LA (as viewed in FIG. 8) can be indicated by using a negative sign (−) or a positive sign (+) before the value of the lateral position LP. In a first sign convention, a negative lateral position (−LP) can indicate a common reference point C_{ref} of a given stud Sx positioned to the left of the longitudinal axis LA and a positive lateral position (+LP) can indicate a common reference point Ce positioned to the right of the longitudinal axis LA. In a second sign convention, a positive lateral position (+LP) can indicate a common reference point Cr of a given stud Sx positioned to the left of the longitudinal axis LA and a negative lateral position (−LP) can indicate a common reference point C_{ref} positioned to the right of the longitudinal axis LA. The first sign convention is followed in the exemplary embodiment depicted in FIG. 8.

The distance along the corresponding stud position line between the stud reference point of a given stud Sx on the longitudinal axis LA and the common reference point C_{ref} of the given stud (i.e., the lateral position of the given stud) can interchangeably be referred to as an orthogonal offset or a lateral offset LO. In embodiments, the common reference point C_{ref} of each stud Sx in the sequence is spaced from the longitudinal axis LA with a nonzero lateral offset LO such that none of the common reference points Cr of the studs in the sequence lie on the longitudinal axis LA. The nonzero lateral offset LO in embodiments comprises a first orthogonal offset in a first direction (i.e., one of left or right of the longitudinal axis as viewed in FIG. 8) and a second lateral offset LO in a second direction opposite to the first direction (i.e., the other of left or right of the longitudinal axis as viewed in FIG. 8). The sign convention (− or +) discussed with respect to the lateral position LP can be used in the same manner to denote the direction of the lateral offset LO relative to the longitudinal axis LA.

In embodiments, each stud has an offset ratio defined as a ratio between the nonzero lateral offset LO and one-half of the passage width w at the common reference point C_{ref}. The offset ratio is determined at the common reference point C_{ref} so that the nonzero lateral offset LO and the passage width w are colinear (i.e., along the stud position line). In embodiments, the offset ratio of the studs, expressed as the result of dividing the absolute value of the nonzero lateral offset LO by one-half of the passage width w, is in a range from 0.050 to 0.780, or from 0.040 to 0.820, or from 0.030 to 0.858, or from 0.020 to 0.897, or from 0.010 to 0.936, or from 0.060 to 0.741, or from 0.070 to 0.702, or from 0.080 to 0.663, or from 0.090 to 0.624, or from 0.100 to 0.585, or from 0.050 to 0.390, or from 0.050 to 0.507, or from 0.050 to 0.624, or from 0.050 to 0.936, or from 0.150 to 0.780, or from 0.120 to 0.780, or from 0.090 to 0.780, or from 0.010 to 0.780, and also comprising all sub-ranges and sub-values between and comprising from 0.005 to 0.960.

Referring now to FIGS. 9 and 10, the orientation of each stud Sx can be defined in the coordinate system by an angle α formed between the stud axis SA of a given stud and a tangent line TL to the longitudinal axis LA at the stud reference point of the given stud. As previously mentioned, the stud axis SA passes through the upstream center Cu and the downstream center Cd of each stud, and the upstream center Cu corresponds to the common reference point C_{ref} in the exemplary embodiments depicted in FIGS. 8-10. As previously mentioned, the stud reference point is located at the intersection of the longitudinal axis LA and the stud position line (i.e., the imaginary line that is normal or substantially normal to the longitudinal axis LA and passes through the common reference point Cre of the given stud). To simplify visualization of the angle α between the stud axis SA and the tangent line TL, FIGS. 9 and 10 show the tangent line TL translated from the stud reference point to the common reference point C_{ref} such that the stud axis SA and the tangent line TL intersect at the common reference point C_{ref}.

As used herein, the subscripts “1,” “2,” “3,” and so on used with reference character “a” refers to the angle of the stud axis SA of the first stud S1, the second stud S2, the third stud S3, and so on, respectively, in the sequence. The subscript “n” used with reference character “α” refers to the angle of the stud axis SA of the last stud Sn in the sequence. The subscripts “1,” “2,” “3,” and so on as well as the subscript “n” are used with reference characters “SA” and “TL” in the same manner these subscripts are used with reference character “a”.

FIG. 9 illustrates the angle α between the stud axis SA and the tangent line TL for the first stud S1 and the last stud Sn in the sequence with the respective common reference points C_{ref} thereof positioned along a straight portion of the fluid channel segment 120. For example, as shown in FIG. 9, the first stud S1 has a stud axis SA₁ that passes through the common reference point C_{ref-S1} (i.e., the upstream center C_{u-S1}) and the downstream center (not labeled) and forms the angle at with the tangent line TL₁ to the longitudinal axis LA at the stud reference point LA₁ (translated to the common reference point C_{ref-S1}). Similarly, the last stud Sn has a stud axis SAₙ that passes through the common reference point C_{ref-Sn} (i.e., the upstream center C_{u-Sn}) and the downstream center (not labeled) and forms the angle αₙ with the tangent line TLₙ to the longitudinal axis LA at the stud reference point LAₙ (translated to the common reference point C_{ref-Sn}). It will be appreciated that the common reference point C_{ref} of any other stud or all studs in the sequence can be positioned along the straight portion of the fluid channel segment 120.

FIG. 10 illustrates the angle α between the stud axis SA and the tangent line TL for a second stud S2 in the sequence with the common reference point C_{ref} thereof positioned along a curved portion of the fluid channel segment 120. For example, as shown in FIG. 10, the second stud S2 has a stud axis SA₂ that passes through the common reference point C_{ref-S2} (i.e., the upstream center C_{u-S1}) and the downstream center (not labeled) and forms the angle at with the tangent line TL₁ to the longitudinal axis LA at the stud reference point LA₁ (translated to the common reference point C_{ref-S1}). It will be appreciated that the common reference point Cre of any other stud or all studs in the sequence can be positioned along the curved portion of the fluid channel segment 120. In embodiments, for example, at least some of the studs Sx in the sequence are arranged along the curved portion of the fluid passage segment Ps.

In embodiments, the angle α of the stud axis SA from the tangent line TL is a nonzero angle such that the stud axis SA is oriented transversely with respect to the tangent line TL (i.e., the stud axis SA is not parallel to the tangent line TL). The nonzero angle α in embodiments comprises a first nonzero angle in a third direction (i.e., one of counterclockwise or clockwise from the tangent line TL as viewed in FIGS. 9 and 10) and a second nonzero angle in a fourth direction opposite to the third direction (i.e., the other of counterclockwise or clockwise from the tangent line TL as viewed in FIGS. 9 and 10).

In embodiments, the first nonzero angle in the third direction or the second nonzero angle in the fourth direction (as viewed in FIGS. 9 and 10) can be indicated by using a negative sign (−) or a positive sign (+) before the value of the nonzero angle α. In a first sign convention, a negative angle (−α) can indicate an angle α of a stud axis SA of a given stud Sx oriented counterclockwise from the tangent line TL and a positive angle (+α) can indicate an angle α of a stud axis SA of a given stud Sx oriented clockwise from the tangent line TL. In a second sign convention, a positive angle (+α) can indicate an angle α of a stud axis SA of a given stud Sx oriented counterclockwise from the tangent line TL and a negative angle (−α) can indicate an angle α of a stud axis SA of a given stud Sx oriented clockwise from the tangent line TL. The first sign convention is followed in the exemplary embodiments depicted in FIGS. 9 and 10. In embodiments, the nonzero angle α of the stud axis SA from the tangent line TL is in a range of −90°<α<90° such that fluid flowing through the fluid passage segment Pₛ in the flow direction will pass and/or interact with the upstream face 166 (FIG. 7) of the stud Sx before the same fluid passes and/or interacts with the downstream face 170 (FIG. 7).

The positions, orientations, and/or number of the studs Sx in the sequence along the fluid passage segment Pₛ are configured to have various relationships and/or patterns that enable high throughput fluid devices (i.e., devices having a flow rate of at least 40 L/min) without comprising mixing quality, pressure drop, or reliability/safety. The fluid passage segment Pₛ has a total number of studs Sx in the sequence. In embodiments, the total number of studs Sx in the sequence is in a range from 2 to 25, or from 5 to 22, or from 8 to 19, or from 11 to 16, or from 12 to 15, or from 11 to 25, or from 11 to 22, or from 11 to 19, or from 11 to 14, or from 2 to 16, or from 5 to 16, or from 8 to 16, or from 13 to 16.

In embodiments, the number and positions of the studs Sx in the sequence have relationships and/or patterns that provide advantages. In such embodiments, the number of the studs with the first lateral offset LO and the number of the studs with the second lateral offset LO differ by at least 1. In such embodiments, the upstream center Cᵤ of most of the studs in the sequence alternates sequentially between the first lateral offset LO and the second lateral offset LO. In such embodiments, the upstream center Cᵤ of at least 10 of the studs in the sequence alternates sequentially between the first lateral offset LO and the second lateral offset LO. In such embodiments, the upstream center of the first 2 studs in the sequence (i.e., the first stud S1 and the second stud S2) has the first lateral offset LO or the second lateral offset LO.

In embodiments, the number and orientations of the studs Sx in the sequence have relationships and/or patterns that provide advantages. In such embodiments, the number of the studs with the first nonzero angle and the number of the studs with the second nonzero angle differ by at least 2. In such embodiments, the number of the studs with the first nonzero angle and the number of the studs with the second nonzero angle differ by at least 3. In such embodiments, the stud axis SA of most of the studs in the sequence alternates sequentially between the first nonzero angle and the second nonzero angle. In such embodiments, the stud axis SA of at least 8 of the studs in the sequence alternates sequentially between the first nonzero angle and the second nonzero angle. In such embodiments, the stud axis SA of the first 2 studs in the sequence (i.e., the first stud S1 and the second stud S2) has the first nonzero angle or the second nonzero angle such that the nonzero angle of the first 2 studs in the sequence have the same direction relative to the tangent line TL. In such embodiments, the stud axis SA of the first 4 studs in the sequence (i.e., the first stud S1, the second stud S2, the third stud S3, and the fourth stud S4) has the first nonzero angle or the second nonzero angle.

Referring to FIGS. 11 and 12 and again to FIG. 2, further details of the fluid path 108 and features thereof are disclosed. The fluid path 108 at the first or upstream end includes the inlet 112 through which one or more different fluids are configured to be introduced concurrently to the fluid passage P. FIG. 11 depicts an embodiment of the inlet 112. The inlet 112 comprises a plurality of sub-inlets such as a first inlet portion 113 and a second inlet portion 114 as shown in FIG. 11. The first inlet portion 113 and the second inlet portion 114 are configured to receive a first fluid and a second fluid, respectively, and maintain separation between the first and second fluids therein for at least a portion of flow through the inlet 112 in the flow direction. In embodiments, the number of sub-inlets is more than 2, for example, 3 sub-inlets, or 4 sub-inlets, or 5 sub-inlets, each configured to receive a respective fluid and maintain separation of that respective fluid from other fluids introduced via other sub-inlets for at least a portion of flow through the inlet 112. The inlet 112 also comprises an outlet portion 115 through which the first fluid and the second fluid exit the inlet 112 into the fluid passage P. In embodiments, the fluids introduced via the sub-inlets are combined prior to exit through the outlet portion 115 as shown in FIG. 11.

FIG. 12 depicts an embodiment of a single mixer unit 124 of the at least one mixer unit discussed above with reference to FIG. 2. The mixer unit 124 comprises wall structures configured to define a chamber 178. The chamber 178 comprises a split of the fluid passage P into at least two sub-passages 182, and a joining 186 of the split passages 182, and a change of passage direction, in at least one of the sub-passages 182, of at least 90 degrees relative to the immediate upstream passage direction. In the embodiment shown, it may be seen in FIG. 12 that both sub-passages 182 change direction in excess of 90 degrees relative to the immediate upstream passage direction of the fluid passage P. The chamber 178 also includes a splitting and re-directing wall 190 oriented crossways to the immediately upstream flow direction and positioned immediately downstream of an entrance 194 of the chamber 178. The upstream side of the splitting and re-directing wall 190 has a concave surface 196.

In embodiments in which the at least one mixer unit 124 comprises a plurality of mixer units, the mixer units 124 can be arranged serially with respect to each other so as to provide multiple successive chambers 178 thereof along a portion of the fluid passage P. In such embodiments, each of the multiple successive chambers 178, for those having an immediately succeeding one of said chambers, further comprises a gradually narrowing exit 198 which forms a corresponding narrowed entrance 194 of the succeeding chamber. In embodiments, two or more groups of the serially arranged mixer units 124 can be respectively positioned along two or more branches of the fluid passage P with a respective group of serially arranged mixer units 124 positioned along a respective branch of the fluid passage P. In such embodiments, the two or more groups of the serially arranged mixer units 124 area also arranged in parallel with respect to each other. Various embodiments and arrangements of mixer units that can be used in the fluid path 108 of the present disclosure are described in U.S. Pat. No. 7,939,033, which is incorporated herein by reference in its entirety.

### EXAMPLES

Various embodiments of the present disclosure can be better understood by reference to the following Examples which are offered by way of illustration. The present disclosure is not limited to the Examples given herein. In the Examples, different embodiments of the fluid channel segment 120 are combined with various arrangements of the fluid structures along the fluid passage P to provide high-throughput fluid paths 108. The high-throughput fluid paths 108 are configured to be incorporated into fluid device, such as a SiC fluid devices.

Referring again to FIG. 1, the SiC fluid devices of the Examples comprise a body 104 having dimensions configured to safely incorporate the high-throughput fluid paths 108 under the pressures and flow conditions described herein. The body 104 can include fillets and/or chambers along the edges thereof. The body 104 of the Examples is a unified body that comprises a first or top body portion 140 and a second or bottom body portion 144 bonded or otherwise sealed to the top body portion 140 at the joining plane 148. Each of the first body portion 140 and the second body portion 144 has a thickness in a range from about 6.650 mm to about 12.350 mm, including all sub-ranges and sub-values therebetween. The thickness in an exemplary embodiment corresponding to the Examples is the same for the first body portion 140 and the second body portion 144. The fluid passage P and other fluid structures disposed along the fluid path 108 are formed partially in the first body portion 140 and partially in the second body portion 144 and extend into the respective first and second body portions 140, 144 at a depth in a range of about 2.800 mm to about 5.200 mm, including all sub-ranges and sub-values therebetween, from the joining plane 148. The depth in an exemplary embodiment corresponding to the Examples is the same for the first body portion 140 and the second body portion 144. The inlet 112 and the outlet 116 of the Examples (except for Example 2 discussed below) extend substantially perpendicular to the top surface 128 and the bottom surface 132 of the body 104.

The high-throughput fluid paths 108 of the Examples are modeled and analyzed to estimate performance attributes thereof, particularly in terms of pressure drop and mechanical reliability (i.e., mechanical fields such as stress, strain, invariants, etc.), using a high flow rate of 40 L/min and a target (internal) pressure. Certain performance attributes of the high-throughput fluid paths 108 according to the Examples are reported in FIGS. 13 and 14 and Table 6 discussed below after the descriptions of the Examples.

### Example 1

A first flow path 108 according to Example 1 comprises an inlet 112, a first group of mixer units 124′, a straight fluid channel segment 120′, a second group of mixer units 124″, and an outlet 116 all of which are arranged sequentially along the flow direction in the order indicated herein. The inlet 112 corresponds to the embodiment described with reference to FIG. 11. The first group of mixer units 124′ comprises three mixer units arranged serially with respect to one another along fluid passage P. The mixer units 124′ correspond to the embodiment described with reference to FIG. 12. The mixer units of the first group of mixer units 124′ are larger than the mixer units of the second group of mixer units 124″. As used herein, the term “larger” used with reference to a size of the mixer units means that the first mixer unit 124′ has a first fluid-containing volume that is larger than a second fluid-containing volume of the second mixer unit 124″.

The straight fluid channel segment 120′ of Example 1 is fluidically connected to the last mixer unit of the first group of mixer units 124′ by a first segment of the fluid passage P. The first segment comprises a first straight portion connected to the exit 198 of the last mixer unit 124′ and a first curved portion connected to the first or upstream end of the straight fluid channel segment 120′. The straight fluid channel segment 120′ of Example comprises a sequence of eight (8) studs arranged along the fluid passage segment Pₛ therein. The positions, orientations, and offset ratios of the studs Sx of the straight fluid channel segment 120′ of Example 1 are indicated in Table 1 using the coordinate system described with reference to FIGS. 8-10. The stud reference point of the first stud S1 (i.e., “Stud Pos. I”) is used as the axial position reference point in the Examples so the axial offset of the first stud S1 will be zero in Table 1 (and Tables 2-4 discussed below).

TABLE 1
Coordinates, Orientations, and Offset Ratios of Studs of Example 1

| | | | | Ratio of Lateral |
|---|---|---|---|---|
| | Axial Offset | | Angle of Stud | Offset to One- |
| | from Stud Pos. 1 | Lateral Offset | Axis with | Half Passage |
| | along Long. Axis | from Long. Axis | Tangent to | Width |
| Stud Pos. | (mm) | (mm) | Long. Axis (deg) | (“Offset Ratio”) |
| 1 | 0.0 | 4.9 | 21.9 | 0.477 |
| 2 | 13.1 | −3.8 | −22.5 | 0.374 |
| 3 | 26.2 | 4.9 | 21.9 | 0.477 |
| 4 | 39.3 | −3.8 | −22.5 | 0.374 |
| 5 | 52.4 | 4.9 | 21.9 | 0.477 |
| 6 | 65.5 | −3.8 | −22.5 | 0.374 |
| 7 | 78.6 | 4.9 | 21.9 | 0.477 |
| 8 | 91.7 | −3.8 | −22.5 | 0.374 |

The straight fluid channel segment 120′ of Example 1 is fluidically connected to the second group of mixer units 124″ by a second segment of the fluid passage P. Starting from the straight fluid channel segment 120′, the second segment comprises (1) a second curved portion connected to the second or downstream end of the straight fluid channel segment 120′, (2) a second straight portion connected to the second curved portion, (3) a first branch that splits the second straight portion of the second segment into a first branch portion and a second branch portion, (4) a second branch that splits the first branch portion into a third branch portion and a fourth branch portion, and (5) a third branch that splits the second branch portion into a fifth branch portion and a sixth branch portion.

The second group of mixer units 124″ comprises twelve mixer units arranged into four subgroups with each subgroup comprising three mixer units arranged serially with respect to one another. A first subgroup of three serially arranged mixer units 124″ is connected to the third branch portion. A second subgroup of three serially arranged mixer units 124″ is connected to the fourth branch portion. A third subgroup of three serially arranged mixer units 124″ is connected to the fifth branch portion. A fourth subgroup of three serially arranged mixer units 124″ is connected to the sixth branch portion.

The four subgroups of mixer units are configured such that a sequentially first mixer unit of the first subgroup is adjacent and fluidically connected to a sequentially first mixer unit of the second subgroup, the sequentially first mixer unit of the second subgroup is adjacent and fluidically connected to a sequentially first mixer unit of the third subgroup, and the sequentially first mixer unit of the third subgroup is adjacent and fluidically connected to a sequentially first mixer unit of the fourth subgroup. The sequentially second mixer units and sequentially third mixer units of each of the first, second, third, and fourth subgroups are configured in the same manner as the sequentially first mixer units of these subgroups.

The second group of mixer units 124″ is fluidically connected to the outlet 116 by a third segment of the fluid passage P. The third segment comprises a plurality of segment portions each of which is fluidically connected to the exit 198 of the sequentially third mixer unit of one of the first, second, third, or fourth subgroups of the second group of mixer units 124″.

### Example 2

A second flow path 108 according to Example 2 comprises an inlet 112, a first group of mixer units 124′, a curved fluid channel segment 120″, a second group of mixer units 124″, and an outlet 116 all of which are arranged sequentially along the flow direction in the order indicated herein. The inlet 112, the first group of mixer units 124′, the second group of mixer units 124″, and the outlet 116 correspond largely to the equivalent fluid structures described in connection with the first flow path 108 of Example 1 except with respect to the following differences regarding the inlet 112 and the outlet 116. In particular, the inlet 112 and the outlet 116 are oriented transversely with respect to the top surface 128 and the bottom surface 132 of the body (i.e., approximately 35 deg. angle) and include round fillets of approximately 3 mm.

The curved fluid channel segment 120″ of Example 2 comprises a curved portion of the longitudinal axis LA disposed at a first or upstream end of the curved fluid passage segment Ps″. The curved fluid channel segment 120″ of Example 2 is fluidically connected to the last mixer unit of the first group of mixer units 124′ by a first segment of the fluid passage P. The first segment comprises a straight portion connected at one end to the exit 198 of the last mixer unit 124′ and at the other end to the first or upstream end of the curved fluid channel segment 120″. The curved fluid channel segment 120″ of Example 2 comprises a sequence of sixteen (16) studs arranged along the fluid passage segment Pₛ therein. The positions, orientations, and offset ratios of the studs Sx of the curved fluid channel segment 120′ of Example 2 are indicated in Table 2 using the coordinate system described with reference to FIGS. 8-10. At least three (3) of the studs of the curved fluid channel segment 120″ of Example 2 are disposed along the curved portion of the longitudinal axis LA, preferably the first three (3) studs of the sequence.

TABLE 2
Coordinates, Orientations, and Offset Ratios of Studs of Example 2

| | | | | Ratio of Lateral |
|---|---|---|---|---|
| | Axial Offset | | Angle of Stud | Offset to One- |
| | from Stud Pos. 1 | Lateral Offset | Axis with | Half Passage |
| | along Long. Axis | from Long. Axis | Tangent to | Width |
| Stud Pos. | (mm) | (mm) | Long. Axis (deg) | (“Offset Ratio”) |
| 1 | 0.0 | 0.6 | −19.0 | 0.054 |
| 2 | 14.2 | 5.2 | −38.0 | 0.510 |
| 3 | 25.1 | −2.9 | 21.0 | 0.287 |
| 4 | 36.9 | 4.4 | −1.0 | 0.428 |
| 5 | 50.2 | −4.0 | 18.0 | 0.386 |
| 6 | 59.4 | 4.0 | −22.5 | 0.394 |
| 7 | 69.4 | −4.0 | 22.5 | 0.393 |
| 8 | 79.4 | 4.0 | −22.5 | 0.394 |
| 9 | 89.4 | −4.0 | 22.5 | 0.393 |
| 10 | 99.4 | 4.0 | −22.5 | 0.394 |
| 11 | 109.4 | −4.0 | 22.5 | 0.393 |
| 12 | 119.4 | 4.0 | −22.5 | 0.394 |
| 13 | 129.4 | −4.0 | 22.5 | 0.393 |
| 14 | 139.4 | 4.0 | −22.5 | 0.394 |
| 15 | 149.4 | −4.0 | 22.5 | 0.393 |
| 16 | 159.4 | 4.0 | −22.5 | 0.394 |

The curved fluid channel segment 120″ of Example 2 is fluidically connected to the second group of mixer units 124″ by a second segment of the fluid passage P that is connected to the second or downstream end of the curved fluid channel segment 120′. Starting from the curved fluid channel segment 120″, the second segment comprises (1) a first branch that splits the curved fluid segment 120″ into a first branch portion and a second branch portion, (2) a second branch that splits the first branch portion into a third branch portion and a fourth branch portion, and (3) a third branch that splits the second branch portion into a fifth branch portion and a sixth branch portion. The second group of mixer units 124″ is connected to the second segment of the fluid passage P in essentially the same manner as described in Example 1. The second group of mixer units 124″ is fluidically connected to the outlet 116 by a third segment of the fluid passage P in essentially the same manner as described in Example 1.

### Example 3

A third flow path 108 according to Example 3 comprises an inlet 112, a first group of mixer units 124′, a curved fluid channel segment 120″, a second group of mixer units 124″, and an outlet 116 all of which are arranged sequentially along the flow direction in the order indicated herein. The inlet 112, the first group of mixer units 124′, the second group of mixer units 124″, and the outlet 116 correspond largely to the equivalent fluid structures described in connection with the first flow path 108 of Example 1.

The curved fluid channel segment 120″ of Example 3 comprises a curved portion of the longitudinal axis LA disposed at a first or upstream end of the curved fluid passage segment Ps″. The curved fluid channel segment 120″ of Example 3 is fluidically connected to the first group of mixer units 124′ in essentially the same manner described in Example 2. The curved fluid channel segment 120″ of Example 3 comprises a sequence of eleven (11) studs arranged along the fluid passage segment Pₛ therein. The positions, orientations, and offset ratios of the studs Sx of the curved fluid channel segment 120′ of Example 3 are indicated in Table 3 using the coordinate system described with reference to FIGS. 8-10. At least three (3) of the studs of the curved fluid channel segment 120″ of Example 3 are disposed along the curved portion of the longitudinal axis LA, preferably the first three (3) studs of the sequence.

TABLE 3
Coordinates, Orientations, and Offset Ratios of Studs of Example 3

| | | | | Ratio of Lateral |
|---|---|---|---|---|
| | Axial Offset | | Angle of Stud | Offset to One- |
| | from Stud Pos. 1 | Lateral Offset | Axis with | Half Passage |
| | along Long. Axis | from Long. Axis | Tangent to | Width |
| Stud Pos. | (mm) | (mm) | Long. Axis (deg) | (“Offset Ratio”) |
| 1 | 0.0 | 3.8 | −42.3 | 0.270 |
| 2 | 16.1 | 9.4 | −17.9 | 0.674 |
| 3 | 23.6 | −2.1 | −16.8 | 0.148 |
| 4 | 43.5 | 5.6 | −22.5 | 0.397 |
| 5 | 53.9 | −8.2 | 22.5 | 0.586 |
| 6 | 68.5 | 8.2 | −22.5 | 0.586 |
| 7 | 81.9 | −8.2 | 22.5 | 0.586 |
| 8 | 95.9 | 8.2 | −22.5 | 0.586 |
| 9 | 109.9 | −8.2 | 22.5 | 0.586 |
| 10 | 123.3 | 8.2 | −22.5 | 0.586 |
| 11 | 137.9 | −8.2 | 22.5 | 0.586 |

The fluidic connections among the curved fluid channel segment 120″ of Example 3, the second segment, the second group of mixer units 124″, the third segment, and the outlet 116 are essentially the same as described in Example 2.

### Example 4

A fourth flow path 108 according to Example 4 comprises an inlet 112, a first group of mixer units 124′, a curved fluid channel segment 120″, a second group of mixer units 124″, and an outlet 116 all of which are arranged sequentially along the flow direction in the order indicated herein. The inlet 112, the first group of mixer units 124′, the second group of mixer units 124″, and the outlet 116 correspond largely to the equivalent fluid structures described in connection with the first flow path 108 of Example 1.

The curved fluid channel segment 120″ of Example 4 comprises a curved portion of the longitudinal axis LA disposed at a first or upstream end of the curved fluid passage segment Ps″. The curved fluid channel segment 120″ of Example 4 is fluidically connected to the first group of mixer units 124′ in essentially the same manner described in Examples 2 and 3. The curved fluid channel segment 120″ of Example 4 comprises a sequence of eleven (11) studs arranged along the fluid passage segment Pₛ therein. The positions, orientations, and offset ratios of the studs Sx of the curved fluid channel segment 120′ of Example 4 are indicated in Table 3 using the coordinate system described with reference to FIGS. 8-10. At least three (3) of the studs of the curved fluid channel segment 120″ of Example 4 are disposed along the curved portion of the longitudinal axis LA, preferably the first three (3) studs of the sequence.

TABLE 4
Coordinates, Orientations, and Offset Ratios of Studs of Example 4

| | | | | Ratio of Lateral |
|---|---|---|---|---|
| | Axial Offset | | Angle of Stud | Offset to One- |
| | from Stud Pos. 1 | Lateral Offset | Axis with | Half Passage |
| | along Long. Axis | from Long. Axis | Tangent to | Width |
| Stud Pos. | (mm) | (mm) | Long. Axis (deg) | (“Offset Ratio”) |
| 1 | 0.0 | 1.9 | −38.2 | 0.139 |
| 2 | 18.3 | 10.5 | −17.4 | 0.778 |
| 3 | 24.3 | −1.3 | −12.5 | 0.099 |
| 4 | 40.0 | 9.2 | −22.5 | 0.682 |
| 5 | 49.9 | −7.1 | 22.5 | 0.528 |
| 6 | 65.2 | 7.3 | −22.5 | 0.539 |
| 7 | 79.5 | −7.8 | 22.5 | 0.576 |
| 8 | 93.5 | 6.9 | −22.5 | 0.508 |
| 9 | 107.6 | −7.6 | 22.5 | 0.559 |
| 10 | 121.4 | 7.0 | −22.5 | 0.516 |
| 11 | 137.2 | −4.4 | 22.5 | 0.328 |

The fluidic connections among the curved fluid channel segment 120″ of Example 4, the second segment, the second group of mixer units 124″, the third segment, and the outlet 116 are essentially the same as described in Examples 2 and 3.

Further attributes of the fluid channel segments 120, 120′, 120″ of the Examples, which attributes are not dependent on the positions and/or orientations of the studs within a given fluid channel segment, are indicated in Table 5.

TABLE 5
Further Attributes of the Fluid Channel Segments of the Examples

| Attribute | Ex. 1 | Ex. 2 | Ex. 3 | Ex. 4 |
|---|---|---|---|---|
| Axial Offset of Stud Pos. | 96.7 | 82.5 | 78.8 | 78.1 |
| 1 from Ref. Pt. (mm) | | | | |
| Stud Upstream Radius (mm) | 2.075 | 2.075 | 2.075 | 2.075 |
| Stud Downstream Radius (mm) | 2.075 | 2.075 | 2.075 | 2.575 |
| Stud Length between Radii | 6.91 | 6.91 | 6.91 | 6.41 |
| Centers (mm) | | | | |
| Passage Width (mm) | 20.4 | 20.5 | 28.0 | 27.0 |
| Passage Height (mm) | 8.0 | 8.0 | 8.0 | 8.0 |
| Ratio Stud Upstream Radius | 0.10 | 0.10 | 0.07 | 0.08 |
| to Passage Width | | | | |
| Ratio Stud Downstream Radius | 0.10 | 0.10 | 0.07 | 0.10 |
| to Passage Width | | | | |
| Ratio Stud Upstream Radius | 0.30 | 0.30 | 0.30 | 0.32 |
| to Stud Length | | | | |
| Ratio Stud Downstream Radius | 0.30 | 0.30 | 0.30 | 0.40 |
| to Stud Length | | | | |
| Ratio Stud Length to | 0.34 | 0.34 | 0.25 | 0.24 |
| Passage Width | | | | |
| Ratio Downstream Radius | 1 | 1 | 1 | 1.24 |
| to Upstream Radius | | | | |

Some of the attributes indicated in Table 5 are described further herein. The attribute “Axial Offset of Stud Pos. 1 from Ref. Pt. (mm)” in Table 5 refers to the distance along the longitudinal axis LA between the stud reference point of the first stud S1 in the sequence (i.e., “Stud Pos. 1”) and an axial position reference point (i.e., “Ref. Pt.”) on the longitudinal axis LA that is different than the stud reference point of the first stud S1. In Table 5, the axial position reference point or Ref. Pt. is the position on the longitudinal axis LA of the fluid passage P at the exit 198 of the closest mixer unit 124′ of the first group of mixer units 124′ upstream from the first stud S1. For instance, the stud reference point of the first stud S1 or Stud Pos. 1 of the straight fluid channel segment 120′ of Example 1 is 96.7 mm downstream from the exit 198 of the closest mixer unit 124′ of the first group of mixer units 124′ in the flow path 108 of Example 1.

The attribute “Stud Length between Radii Centers (mm)” in Table 5 refers to the linear distance between the upstream center Cᵤ (i.e., at the center of curvature of the upstream face 166) of a given stud Sx and the downstream center Cd (i.e., at the center of curvature of the downstream face 170) of the given stud.

The different ratios indicated in Table 5 illustrate relationships between features of the studs and features of the fluid channel segments in the Examples. These relationships are useful to show how one feature can scale with another feature. For instance, the attributes “Ratio Stud Upstream Radius to Passage Width” and “Ratio Stud Downstream Radius to Passage Width” illustrate how the radii of the studs can scale with a change in the passage width. The attributes “Ratio Stud Upstream Radius to Stud Length” and “Ratio Stud Downstream Radius to Stud Length” illustrate how the radii of the studs can scale with a change in the stud length. The attribute “Ratio Stud Length to Passage Width” illustrates how the length of the studs can scale with a change in the passage width. In embodiments, the range for any of the ratio attributes indicated in Table 5 can be +/−2.5%, or +/−5%, or +/−7.5%, or +/−10%, or +/−15% or +/−20% of the value of the ratio for any one of the Examples. In embodiments, the range for any of the ratio attributes indicated in Table 5 can include the minimum and maximum values of the ratios for all of the Examples. For instance, the range of the attribute “Ratio Stud Length to Passage Width” can be from 0.24 (Example 4) to 0.34 (Examples 1 and 2). The range of the attribute “Ratio Stud Length to Passage Width” can also be expanded or narrowed by a percentage, for example, 2.5%, or 5%, or 7.5%, or 10%, or 15%, or 20%.

In embodiments, the upstream radius, the downstream radius, and/or the stud length can scale with the maximum internal pressure. Moreover, the attribute “Ratio of Stud Downstream Radius to Stud Upstream Radius” can increase with the maximum internal pressure.

### Performance Attributes—All Examples

FIG. 13 compares the maximum computed stresses at different positions along the high-throughput fluid paths 108 according to Examples 1-4 and Comparative Example. To compute the stresses, finite elements analysis (FEA) was performed assuming the following material properties and boundary conditions. The material was silicon carbide (SiC) with a Young's Modulus (E)=420 GPa and Poisson's ratio (ν)=0.16. A symmetry condition was set on the joining plane, for example, as indicated at 148 in FIG. 1. A pressure of 100 bar (10 MPa) applied within the fluid passage P. Displacement was blocked in 2 directions for a first node (uₓ, u_{y}=0), for example, as indicated at 150 in FIG. 1. Displacement was blocked in 1 direction for a second node (uₓ=0), for example, as indicated at 151 in FIG. 1. The maximum stress (von Mises) was calculated at two locations: (1) at the bottom or corner of the fluid passage P and (2) at the midplane or joining plane of the body 104, the latter of which is important when the body is sealed at the joining plane.

In the Comparative Example, which is configured with a flow path allowing for a flow rate up to 20 L/min under a reaction pressure of up to 18 bar at up to 200° C., the maximum corner stress of 94 MPa and the maximum midplane stress of 61 MPa occur within the fluid channel segment when this configuration is modeled for a 100 bar pressure. As previously noted, the high-throughput flow paths of Examples 1-4 allow a flow rate of 40 L/min.

In Example 1, the maximum corner stress of 230 MPa occurs within the third segment (between the second group of mixer units 124″ and the outlet 116) and the maximum midplane stress of 83 MPa occurs within the fluid channel segment 120, 120′. In Example 2, the maximum corner stress of 136 MPa and the maximum midplane stress of 58 MPa occurs within the inlet 112 just before fluidic communication into the first group of mixer units 124′. The narrower passage width w and the higher stud density (i.e., more of the volume of the fluid passage segment is occupied by the studs) enable a substantial reduction in stress values compared to the stress values of Example 1. In Example 3, the maximum corner stress of 187 MPa and maximum midplane stress of 94 MPa occur within the fluid channel segment 120, 120″. The stresses of Example 3 are increased compared to those in Example 2, but the stresses are nonetheless within acceptable levels. The fluid channel segment of Example 3 includes fewer studs than the fluid channel segment of Example 2 so as to improve hydrodynamic performance as discussed in more detail below.

In Example 4, the maximum corner stress of 176 MPa and the maximum midplane stress of 76 MPa occur within the fluid channel segment 120, 120″. The various structural modifications of the fluid channel segment of Example 4 compared to the other Examples and the Comparative Example (i.e., the number of studs, the positions and/or orientations of the studs, the downstream radius being larger than the upstream radius, the stud length, etc.) allowed a significant reduction in the stresses with very limited effect on the hydrodynamic performance as discussed in more detail below.

The hydrodynamic performance of the high-throughput flow paths of Examples 1-4 were evaluated by performing series of computational fluid dynamics (CFD) simulations. FIG. 14 illustrates the total pressure drop along the high-throughput fluid paths of Examples 1-4. A flow rate of 40 LJmin of water at room temperature was used for the pressure drop simulation. The target total pressure drop was less than 5 bar. As shown in FIG. 14, the high-throughput flow paths of Examples 1, 3, and 4 exceed this target pressure drop whereas the flow path of Example 2 is slightly above the target pressure drop.

Table 6 reports the mixing uniformity and flow rates at different positions along the high-throughput fluid paths of Examples 1-4. Two miscible fluids were used for the mixing simulation: (1) Fluid A (organic): flowrate: 6.8 l/min, density 890 kg/m³, viscosity 0.73 mPa·s; (2) Fluid B (acids): flowrate: 26 l/min, density 1400 kg/m³, viscosity 3.67 mPa·s. Fluid A and Fluid B were delivered from different inlets (i.e., the first inlet portion 113 and the second inlet portion 114 as shown in FIG. 11).

TABLE 6
Mixing Uniformity and Flow Rates of Examples 1-4

| Example | Position | | | | | |
|---|---|---|---|---|---|---|
| No. | 1 | 2 | 3 | 4 | 5 | 6 |

Uniformity Index Fluid A

| | | | | | | |
|---|---|---|---|---|---|---|
| Ex. 1 | 0.9969 | 0.9997 | 0.9999 | 0.9999 | 0.9999 | 0.9997 |
| Ex. 2 | 0.9950 | 0.9999 | 0.9999 | 0.9999 | 0.9999 | 0.9991 |
| Ex. 3 | 0.9995 | 0.9999 | 0.9999 | 0.9999 | 0.9999 | 0.9999 |
| Ex. 4 | 0.9960 | 0.9999 | 0.9999 | 0.9999 | 0.9999 | 0.9997 |

Flow Rate of Mass Fraction Fluid A, kg/s

| | | | | | | |
|---|---|---|---|---|---|---|
| Ex. 1 | 0.0440 | 0.0108 | 0.0120 | 0.0110 | 0.0106 | 0.0440 |
| Ex. 2 | 0.0448 | 0.0123 | 0.0106 | 0.0104 | 0.0118 | 0.0450 |
| Ex. 3 | 0.0444 | 0.0124 | 0.0100 | 0.0101 | 0.0120 | 0.0445 |
| Ex. 4 | 0.0447 | 0.0111 | 0.0115 | 0.0115 | 0.0107 | 0.0447 |

Mixing uniformity and flow rates were evaluated along the flow paths of Examples 1-4 at specific positions: Position (1) at the exit 198 of the last mixer unit of the first group of mixer units 124′; Position (2) at the exit 198 of the last mixer unit of the first subgroup of mixer units of the second group of mixer units 124″: Position (3) at the exit 198 of the last mixer unit of the second subgroup of mixer units of the second group of mixer units 124″; Position (4) at the exit 198 of the last mixer unit of the third subgroup of mixer units of the second group of mixer units 124″; Position (5) at the exit 198 of the last mixer unit of the fourth subgroup of mixer units of the second group of mixer units 124″; and Position (6) slightly before the outlet 116.

Mixing uniformity is important for chemical performance of a fluid device. Simulations show that Example 3 has highest mixing uniformity quality while having slight imbalance in flow rates in the parallel mixer units (i.e., the first, second, third, and fourth subgroups at positions 2, 3, 4, 5, respectively). The issue with flow rate imbalance was attended in Example 4 by adjusting the passage width w at the respective exit 198 of each of the subgroups of mixer units. Without being bound by theory, it is believed that the higher uniformity index Example 3 was achieved by placing a straight segment of the fluid passage P before mixing cell rows so as to reduce impact of centrifugal forces.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

1. A fluid channel segment, comprising:
a fluid passage segment extending through a portion of a body, the fluid passage segment having a longitudinal axis that lies substantially in an axis plane, a passage height normal to the axis plane, a passage width normal to the passage height and the longitudinal axis, and a flow direction through the fluid passage segment; and
a plurality of studs arranged in a sequence along the fluid passage segment, wherein:
each stud extends across the fluid passage segment with a stud height corresponding to the passage height of the fluid passage segment,
no more than two studs are positioned across the passage width of the fluid passage segment,
each stud has a continuous surface that defines a periphery of the stud, the continuous surface having a common elongate shape that is symmetrical about a symmetry plane oriented parallel to the stud height and, when viewed in the axis plane, the symmetry plane corresponds to a stud axis of each stud that passes through a common reference point on each stud,
the studs are spaced from each other in the flow direction with a nonzero axial offset relative to the longitudinal axis, and
the stud axis of each stud has a nonzero angle α with a tangent to the longitudinal axis at an intersection of the longitudinal axis with a line that is normal thereto and passes through the common reference point, the nonzero angle of the first 2 studs in the sequence having the same direction relative to the tangent.

2. The fluid channel segment of claim 1, wherein the continuous surface comprises two convex faces spaced apart at opposing ends of the stud and two planar faces connecting the two convex faces at respective tangents thereof.

3. The fluid channel segment of claim 1, wherein the continuous surface comprises exactly two convex faces spaced apart at opposing ends of the stud and exactly two planar faces connecting the two convex faces at respective tangents thereof.

4. The fluid channel segment of claim 2, wherein the two convex faces comprise an upstream face and a downstream face positioned upstream and downstream, respectively, along the fluid passage segment relative to the flow direction.

5. The fluid channel segment of claim 4, wherein each of the upstream face and the downstream face has a radius, and wherein the radius of each of the upstream face and the downstream face is in a range of from about 1.850 mm to about 2.800 mm.

6. (canceled)

7. (canceled)

8. The fluid channel segment of claim 5, wherein each stud has an upstream center at the center of curvature of the upstream face when viewed in the plane, the upstream center of each stud corresponding to the common reference point and having a nonzero lateral offset LO relative to the longitudinal axis.

9. The fluid channel segment of claim 8, wherein the nonzero lateral offset LO comprises a first lateral offset LO in a first direction and a second lateral offset LO in a second direction opposite to the first direction.

10. The fluid channel segment of claim 9, wherein each stud has an offset ratio defined as a ratio between the absolute value of the nonzero lateral offset LO and one-half of the passage width at the upstream center, wherein the offset ratio of the studs is in a range from about 0.040 to about 0.820.

11. The fluid channel segment of claim 9, wherein one or more of:
the stud axis of each stud passes through the upstream center and a downstream center at the center of curvature of the downstream face when viewed in the plane,
the nonzero angle comprises a first nonzero angle in a third direction and a second nonzero angle in a fourth direction opposite to the third direction, and
the number of the studs with the first lateral offset LO and the number of the studs with the second lateral offset LO differ by at least 1.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. The fluid channel segment of claim 5, wherein the radii of the upstream and downstream faces are identical.

24. The fluid channel segment of claim 5, wherein the radii of the upstream and downstream faces are different.

25. (canceled)

26. The fluid channel segment of claim 11, wherein a length of each of the studs between the upstream center and the downstream center is in a range from about 6.185 mm to about 7.135 mm.

27. (canceled)

28. (canceled)

29. The fluid channel segment of claim 1, wherein one or more of:
the fluid passage segment includes a curved portion disposed at an upstream end thereof relative to the flow direction, at least some of the studs are arranged along the curved portion,
the passage height is in a range from about 5 mm to about 10 mm, and
the passage width is in a range from about 18 mm to about 30 mm.

30. (canceled)

31. (canceled)

32. (canceled)

33. (canceled)

34. (canceled)

35. (canceled)

36. (canceled)

37. The fluid channel segment of claim 1, wherein a material of the body and the studs comprises silicon carbide (SiC), and wherein the body and the studs have a maximum stress of approximately 190 MPa under an internal pressure of approximately 100 bar.

38. (canceled)

39. (canceled)

40. A fluid channel segment, comprising:
a fluid passage segment extending through a portion of a body, the fluid passage segment having a longitudinal axis that lies substantially in an axis plane, a passage height normal to the axis plane, a passage width normal to the passage height and the longitudinal axis, and a flow direction through the fluid passage segment; and
a plurality of studs arranged in a sequence along the fluid passage segment, wherein:
each stud extends across the fluid passage segment with a stud height corresponding to the passage height of the fluid passage segment,
no more than two studs are positioned across the passage width of the fluid passage segment,
each stud has a continuous surface that defines a periphery of the stud, the continuous surface having a common elongate shape that is symmetrical about a symmetry plane oriented parallel to the stud height and, when viewed in the axis plane, the symmetry plane corresponds to a stud axis of each stud that passes through a common reference point on each stud,
the studs are spaced from each other in the flow direction with a nonzero axial offset relative to the longitudinal axis,
the stud axis of each stud has a nonzero angle α with a tangent to the longitudinal axis at an intersection of the longitudinal axis with a line that is normal thereto and passes through the common reference point, and
the continuous surface of each stud comprises two convex faces spaced apart at opposing ends of the stud and two planar faces connecting the two convex faces at respective tangents thereof, the two convex faces comprising an upstream face and a downstream face positioned upstream and downstream, respectively, along the fluid passage segment relative to the flow direction, the upstream face having a first radius and the downstream face having a second radius that is larger than the first radius.

41. A fluid path, comprising:
the fluid channel segment of claim 1, the fluid passage segment of the fluid channel segment defining a portion of a fluid passage extending through the body;
an inlet disposed at a first end of the fluid passage, the inlet configured to separate at least two fluids introduced concurrently to the fluid passage via the inlet;
an outlet disposed at a second end of the fluid passage spaced from the first end, the flow direction configured to convey the at least two fluids from the inlet, through the fluid channel segment, and to the outlet; and
a mixer unit disposed upstream from the fluid channel segment along the fluid passage relative to the flow direction, the mixer unit configured to mix the at least two fluids.

42. The fluid path of claim 41, wherein the mixer unit comprises a plurality of mixer units, the fluid channel segment disposed downstream from a first group of the mixer units and upstream from a second group of the mixer units relative to the flow direction.

43. The fluid path of claim 42, wherein the first group of mixer units comprises mixer units that are arranged serially with respect to one another.

44. The fluid path of claim 41, wherein the second group of mixer units comprises mixer units that arranged serially and in parallel with respect to one another.

45. The fluid path of claim 41, wherein a maximum von Mises stress at a joining plane of the body is in a range from about 50 MPa to about 100 MPa under an internal pressure of about 100 bar.

46. (canceled)
